(19) United States
(12) Patent Application Publication
(10) Pub. No.: US 2007/0266616 A1
(43) Pub. Date: Nov. 22, 2007

(54) Fishing rod reel clip connector

(76) Inventor: Peter A. Rienzo, Colts Neck, NJ (US)

Correspondence Address: Charles I. Brodsky, 2 Bucks Lane, Marlboro, NJ, 07746, US

(21) Appl. No.: 11/881,242

(22) Filed: Jul. 27, 2007

Related U.S. Application Data
(63) Continuation-in-part of application No. 10/314,495, filed on Dec. 9, 2002, now abandoned.

(51) Int. Cl. A01K 97/10; B63B 17/00

(52) U.S. Cl. 43/21.2; 114/364

(57) ABSTRACT

A fishing rod holder mounted within a gunwale of a boat, and a compartment cooperating therewith storing a spring-tensioned winding device joined at one end to a stainless steel line having a clip at its opposite end for temporary securement to a reel attached to a rod being held, with the stainless steel line being able to be reached and withdrawn through an openable door in the compartment to tether the rod and reel against accidental loss.

### CROSS-REFERENCE TO RELATED APPLICATIONS

This Application is a Continuation-in-Part of application Ser. No. 10/314,495 filed Dec. 9, 2002.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to deep sea fishing, in general, and to the mounting of fishing rod holders when engaging in deep sea fishing, in particular.

2. description of the Related Art

Fishing rod hold-down systems mounted in the gunwale or to the floor of a fishing boat are known, as may be purchased from the Indiana Marine Company of Westfield, Ind. A buckle at the end of a strap allows the fitting of one or more rods to be held in a generally horizontal position, parallel to the floor of the boat as the boat motors about, holding the rod(s) neatly in place.

Flush mounted rod holders are also known for insertion within the gunwale of the boat at its stern, in providing vertical positioning of the rods for fishing off the back of the boat. Such fishing rods are typically secured by a fabric strap having a clip at one end connected to the reel, and a loop at the opposite end tied to a boat cleat in the cockpit area. The resulting arrangement to prevent the reel and its attached rod from being pulled from the boat when fighting a large fish is offered as an alternative to the angler clipping his/her very expensive, large reel to the fighting chair so as to protect against loss of the equipment. As will be appreciated, however, with upwards of six fishermen using such rods simultaneously at the cockpit area, an entanglement of the various straps frequently occurs as the fisherman move about—oftentimes leading to one or another tripping and/or falling, or simply just a tangling of the lines while trying to land the fish.

### SUMMARY OF THE INVENTION

As is well known and understood, deep sea fishermen utilizing very expensive gear are very much concerned with the maintenance of their various equipment, both in preserving their operating potential, and in keeping everything as neat as possible when in use. As will become clear from the following description, the fishing rod reel clip connector of the present invention continues these objectives, and combines certain aspects of the hold-down systems with those of the flush mounting systems in providing a deep sea fishing arrangement which prevents loss of these expensive rods and reels.

As will be seen from the description below, the present invention employs a fishing rod holder mounted within a gunwale of a boat and a compartment incorporated therewith storing a line having a clip at one of its ends for temporary securement to a reel attached to the rod being held. In a preferred embodiment of the invention, access to the line in the compartment is through an openable hatch—which may include a flip-open door and one which is notched, as well. Such line is preferably of stainless steel (plastic coated or otherwise), and may be of a length so that when pulled through the openable hatch extends a distance of at least 12 inches so as to easily couple by means of the clip to a reel coupled with the fishing rod used. Such clip then offers the protection against loss desired while the length of line may be as long as needed. The opposite end of the line, on the other hand, may be secured to any appropriate type of spring-tensioned line or cord winding device—such as those described in U.S. patents to Eckhaus U.S. Pat. No. 4,935,585), Oshikawa (U.S. Pat. No. 5,898,472), Shih (U.S. Pat. No. 5,954,288), Weise (U.S. Pat. No. 6,902,029) and Tamborrino U.S. Pat. No. 6,918,669).

As will be appreciated, the greater the length of stainless steel line stored within the compartment, the easier it will be for the deep sea fisherman to move about the cockpit of the boat while fighting a fish—without being restricted to the cleat or boat chair area—, while at the same time being assured that should the rod and reel be pulled from his/her hands, the gear will be protected against floating away by the recoil characterizing the retractable line of the spring-tensioned winder, returning the line to a quiescent length and returning the rod and reel back to the boat. As will also be appreciated, should the fish still be on the hook at that time, the retraction afforded gives to the angler a second chance of landing it upon the retrieval of the rod and reel brought about by the automatic recoiling action.

As will be seen from the description below, two embodiments of the invention are set out. In one, a fishing rod holder is mounted flush within the gunwale of the boat in the usual manner, with the rod in a vertically extending position angled rearwardly of the boat, with its reel attached beneath. The compartment storing the retractable line and winding device is then also included within the gunwale, separate from the holder, and located rearwardly of the fishing rod holder, toward the stern. In the second embodiment, the compartment is integrated with the fishing rod holder itself within the gunwale, on a side of the rod holder opposite from that where the reel is attached.

### BRIEF DESCRIPTION OF THE DRAWINGS

These and other features of the present invention will be more clearly understood from a consideration of the following description, taken in connection with the accompanying Drawings, in which:

FIG. 1 pictorially illustrates a cockpit area of a fishing boat helpful in an understanding of the advantages of the present invention;

FIG. 2 illustrates a top view of a portion of the gunwale of the boat in accordance with a first embodiment of the invention; and

FIG. 3 is a pictorial view depicting the fishing rod reel clip connector according to a second embodiment of the invention.

### DETAILED DESCRIPTION OF THE INVENTION

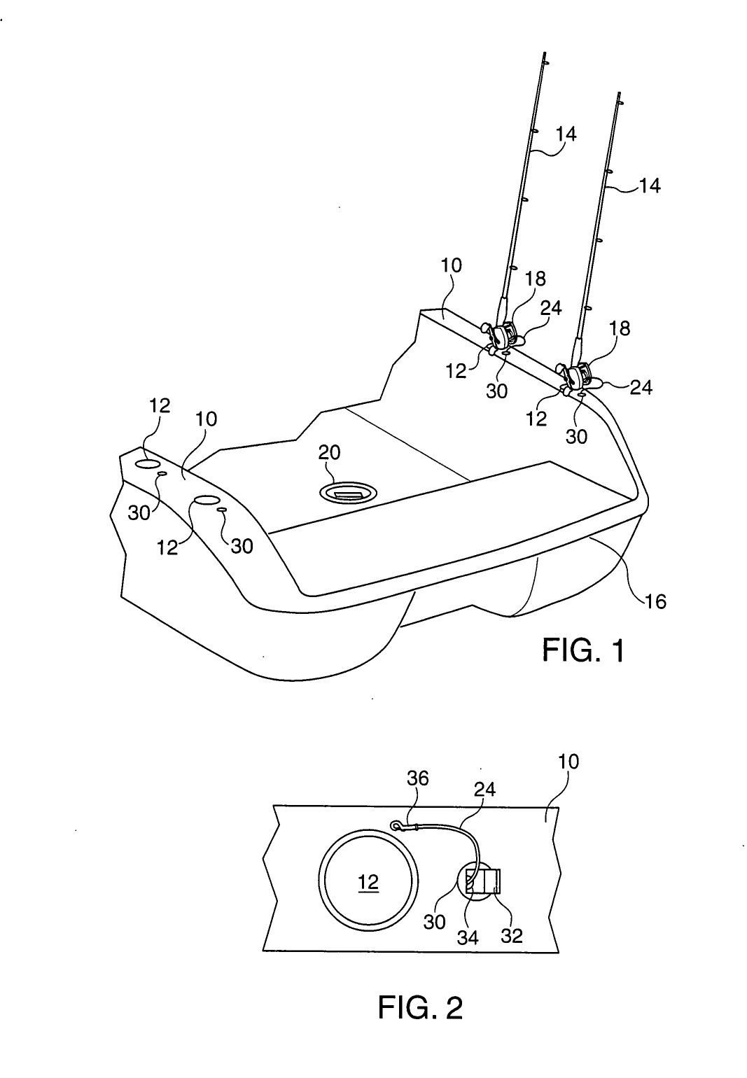

In FIGS. 1 and 2, the gunwale of a boat 10 is shown with a series of flush mounted rod holders 12 of conventional construction in which a series of fishing rods 14 are vertically positioned extending rearwardly of the boat toward its stern 16. In the prior art protections against loss of the equipment, the attached reels 18 at the underside of the rods 14 are coupled by means of a clip and strap to one of the several cleats usually found adjacent the cockpit area, as at 20, or to a fighting chair. As will be recognized, these straps—with their clip connectors to the reel 18 at one end, and open loops surrounding the cleat 20 at their opposite ends—may be upwards of 10, 15 and 20 feet long, and of a fabric construction.

To reduce the possibility of these straps intertangling, and/or the tripping thereon that might frequently result, the present invention, in a first embodiment, employs a compartment 30 with an openable hatch 32 through which a retractable line 24 can be withdrawn from off an included spring-tensioned winding device. Such hatch may include a flip-open door, to permit easy access with the door having a notch 34 through which the line 24 can extend in being pulled to connect with the reel 18 by means of an included clip 36 of any type configuration. Such retractable line 24 may be of stainless steel, plastic-coated if desired (and preferably of a length to be pulled through the door 32 a distance of at least 12 inches, so as to allow the angler to easily move about the boat. The clip 36 is provided at the end of the retractable line 24 to couple with the reel 18 mounted on the fishing rod 14.

With the fishing rod 14 and its attached reel 18 being withdrawn from the rod holder 12, the angler can easily move about the cockpit a distance governed by the length of retractable line stored in the compartment 30. If, somehow, the rod 14 and reel 18 were pulled overboard, rather than being lost to the sea, the nature of the line 24 and its securement to the tensioned winding device would recoil both the line to its quiescent length and the rod and the reel back towards the boat in saving the equipment. Many types of retractable systems are known and available beyond those disclosed in the aforementioned patents, such as those typically found in recoiling the retractable plug-in cords of vacuum cleaner fabrications, or of tape measures, or in dog restraints on a leash that automatically shortens or lengthens as the cord, tape or leash is pulled out and about and which automatically return to the closed, quiescent recoiled position once released. As will be appreciated, the end result would be not only a retention of the rod with its very expensive reel still attached, but a second chance at landing the fish if it were still hooked to the end of the line. In this respect, it will be understood that the clip 36 could be set first below the hatch 32 when stored, which could be provided with an underlying pit or cavity to allow the clip to lie flat prior to use.

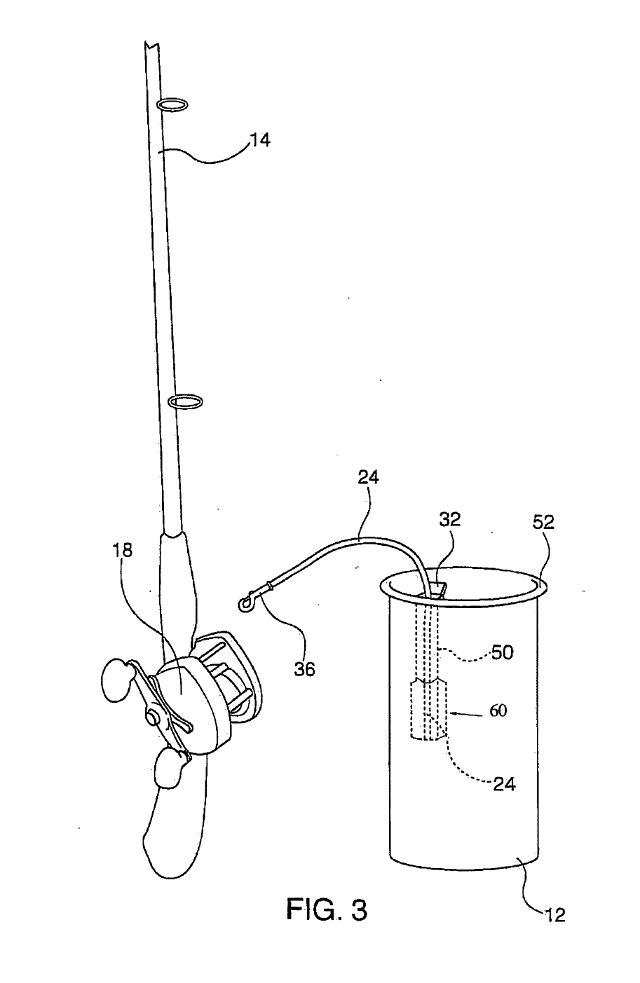

As will be readily understood, the construction envisioned by this first embodiment is most appropriate for a new construction of a boat in that it otherwise would require additional drilling into the gunwale to insert the storage compartment for the retractable line and for the spring-tensioned winding device. Many boat owners might resist any such drilling, even to protect their rods and reels against loss. In such situation, a second embodiment of the invention might be more appropriate, through a redesign of the fishing rod holder to itself include the storage compartment for the retractable line and the winding device. Such an arrangement is shown in FIG. 3 where the compartment is at 50 on a side of the fishing rod holder away from the stern when mounted flush. As will be appreciated, the flange 52 of the rod holder would continue to be mounted flush within the gunwale by screws through a series of apertures in giving the fishing rod 14 the angular tilt illustrated in FIG. 1. As with the first embodiment of the invention, opening the hatch 32 permits reaching in to access the retractable line 24, and pulling it from the compartment 50 by means of the clip 36 which is then to be connected to the reel 18. The line 24 is coupled at its opposite end to the winding device 60, which automatically recoils the line when the tension on the line is released.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the scope of the invention.

I claim:

1. A fishing rod reel clip connector comprising:
a fishing rod holder for mounting a fishing rod and attached reel within a gunwale of a boat, a compartment along said gunwale storing a spring-tensioned winding device joined with one end of a retractable line of adjustable length;
means connecting an opposite end of said retractable line to temporarily secure with said attached reel; and
with said spring-tensioned winding device being operative to automatically recoil said line to a quiescent length and said rod and reel back towards said gunwale if said rod and reel were to accidentally fall from the boat into the water.

2. The fishing rod reel clip connector of claim 1 wherein said compartment includes an openable hatch.

3. The fishing rod reel clip connector of claim 2 wherein said hatch includes a flip-open door.

4. The fishing rod reel clip connector of claim 2 wherein said hatch includes a flip-open notched door.

5. The fishing rod reel clip connector of claim 1 wherein said compartment stores a retractable stainless steel line.

6. The fishing rod reel clip connector of claim 1 wherein said compartment stores a retractable plastic-coated stainless steel line.

7. The fishing rod reel clip connector of claim 1 wherein said retractable line is of a length to be pulled to said attached reel a distance of at least 12 inches.

8. The fishing rod reel clip connector of claim 1, also including a clip at said retractable line end.

9. The fishing rod reel clip connector of claim 1 wherein said compartment is located on said gunwale rearwardly of said fishing rod holder.

10. The fishing rod reel clip connector of claim 1 wherein said compartment includes a flip-open door storing a retractable stainless steel line of a length to be pulled to said attached reel a distance of at least 12 inches, and wherein a clip is included at said retractable line end for temporary securement to said reel.

11. The fishing rod reel clip connector of claim 10 wherein said compartment is integrated with said fishing rod holder within said gunwale on a side of said gunwale opposite from that where said reel is attached to said rod.

12. The fishing rod reel clip connector of claim 11 wherein said fishing rod holder is mounted flush with said gunwale of said boat.
